(19) United States
(12) Patent Application Publication
(10) Pub. No.: US 2009/0000673 A1
(43) Pub. Date: Jan. 1, 2009

(54) Electronically controlled pressure regulator for a mechanical returnless fuel system

(75) Inventor: Dhyana Ramamurthy, Novi, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 11/823,408

(22) Filed: Jun. 27, 2007

(51) Int. Cl. F16K 31/02

(52) U.S. Cl. 137/487.5; 251/129.15

(57) ABSTRACT

A pressure regulator as part of a vehicle fuel pump module may lie within a pressure regulator case, be powered by a battery and controlled by a controller. The pressure regulator may employ a spring secured by a spring holder and held within a pressure regulator spring case. A sealing pressure plate sub-assembly may have a ball element at the top and both may pass through the spring and spring holder and contact a solenoid plunger of a solenoid that is located at an end of the spring case. When the controller activates the solenoid, the solenoid plunger moves and contacts the pressure plate sub-assembly to effect temporary stoppage of the flow of fuel to jet pumps and to a reservoir. The solenoid case may have a diameter equal to, less than, or greater than the diameter of the pressure regulator spring case.

### FIELD

The present disclosure relates to an electronically controlled, solenoid-actuated pressure regulator for a mechanical returnless fuel system.

### BACKGROUND

The statements in this section merely provide background information related to the present disclosure and may not constitute prior art. Conventional vehicular fuel systems, such as those installed in automobiles, may employ a “return fuel system” whereby a fuel supply tube is utilized to supply fuel not only from a fuel tank to an engine, and a fuel return line is utilized to return, hence “return fuel system,” unused fuel from the engine to the fuel tank. Such return fuel systems require the use of both, a supply line to the engine and a return fuel line from the engine. More modern vehicles typically employ a “returnless fuel system” that may either be mechanically or electronically controlled.

Regarding such returnless fuel systems, such as a mechanical returnless fuel system (“MRFS”), only a fuel supply line from a fuel tank to an engine is utilized; therefore, no return fuel line from the engine to the fuel tank is necessary. As a result, an MRFS only delivers the volume of fuel required by an engine, regardless of the varying degree of the volume of fuel required; however, the fuel pump operates at 100% capacity irrespective of engine demand, with excess or unused fuel being discharged through a fuel pump module via a pressure regulator, which traditionally has had the role of relieving fuel pressures above a predetermined fuel pressure. While satisfactory for their given applications, mechanical returnless fuel systems are not without their share of limitations.

One such limitation of current mechanical returnless fuel systems utilizing a mechanical pressure regulator is that during initial starting or immediate restarting of an internal combustion engine, fuel vapor may be present within a fuel rail adjacent an engine or within a fuel line leading from the fuel tank to the fuel rail. Such fuel vapors may hinder or prevent engine starting. FIG. 11 depicts a known pressure regulator 2 adjacent a fuel filter 6 while FIG. 12 depicts the known pressure regulator 2 that regulates fuel pressure with the use of a spring 4. Because mechanical pressure regulators currently are generally manufactured to have one set pressure at which to maintain the fuel pressure, as governed by the spring 4, the fuel vapor in the fuel line or fuel rail may not be subjected to pressures high enough to permit the vapor to be compressed to ease or quicken engine starting or re-starting. Pressures higher than the fuel vapor pressure may compress the fuel vapors to be re-absorbed into the liquid fuel.

In present systems, fuel vapors within a fuel line or rail may not become compressed because upon turning of an ignition and starting of a fuel pump, the mechanical pressure regulator may open immediately and prevent the fuel line pressure from increasing above the pressure at which the pressure regulator opens. In other words, the pressure at which the pressure regulator opens is not high enough to form a liquid from any vapor existing in the fuel line.

When the fuel pressure can not increase above the opening pressure of the pressure regulator, fuel vapors in the fuel line and rail may remain, which may cause vapor lock and thus, engine starting problems. Such a problem is more likely to occur on hot summer days, such as for example, when fuel temperatures are at or above an ambient temperature and pressure at which fuel line fuel vapor may be generated. Fuel vapor may occur even more so if a vehicle is on a macadam or black-surface road with such an ambient temperature and direct sunlight. Direct sunlight on the road may further increase the temperature of a vehicle fuel line as heat radiates from the road surface, such as a black-surface road.

Another limitation of current MRFS with a mechanical pressure regulator that discharges fuel at a predetermined pressure is that tailpipe emissions during a poor start, such as incomplete combustion, could be higher and less environmentally friendly than when the fuel pressure in the fuel system is increased above the pressure regulator setting utilized during normal or steady state engine running. Therefore, increased fuel pressure during engine starting, over and above normal operating pressure, is desired.

What is needed then is a device that does not suffer from the above limitations. This, in turn, will provide a device within a MRFS that alters fuel pressure within a fuel system fuel line during engine starting and that improves tailpipe emissions in vehicles employing internal combustion engines.

### SUMMARY

A fuel pressure regulator within a fuel pump module may employ a biasing element, such as a spring, secured in part by a holder, which are both contained by a pressure regulator biasing element case. A sealing pressure plate sub-assembly may have a ball element at an end, with a length of the sub-assembly passing through the spring and spring holder to contact a solenoid plunger protruding from a solenoid that is located at an end of the spring case. The solenoid may be housed within a case having a diameter that may be equal to, smaller than or greater than the diameter of the spring case. Upon the controller activating the solenoid, the solenoid plunger will project farther into the pressure regulator to contact the sub-assembly and effect temporary stoppage of the flow of fuel to jet pumps and to a reservoir that causes an increase in fuel pressure to the vehicle engine. The solenoid case may have a diameter equal to, less than, or greater than the diameter of the pressure regulator spring case, depending upon the installation or application. The solenoid may be a linear or rotary solenoid.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a side view of a vehicle depicting the general location of an engine and fuel system;

FIG. 2 is a perspective view of a fuel pump module;

FIG. 3 is a side view of a fuel pump module depicting the location of a pressure regulator;

FIG. 4 is an enlarged view of a pressure regulator in accordance with an embodiment of the teachings of the present invention;

FIG. 5 is an enlarged view of a pressure regulator in accordance with an embodiment of the teachings of the present invention;

FIG. 6 is an enlarged view of a pressure regulator in accordance with an embodiment of the teachings of the present invention;

FIG. 7 is an enlarged view of a pressure regulator in accordance with an embodiment of the teachings of the present invention;

FIG. 8 is an enlarged view of a pressure regulator employing a rotary solenoid in accordance with an embodiment of the teachings of the present invention;

FIG. 9 is an enlarged view of a pressure regulator employing a rotary solenoid in accordance with an embodiment of the teachings of the present invention;

FIG. 10a is an end view of a lobe of a solenoid device in accordance with the teachings of the present invention;

FIG. 10b is an end view of a lobe of a solenoid device in accordance with the teachings of the present invention;

FIG. 11 is a side view of a pressure regulator and reservoir currently known in the art; and

FIG. 12 is an enlarged view of a pressure regulator currently known in the art.

### DETAILED DESCRIPTION

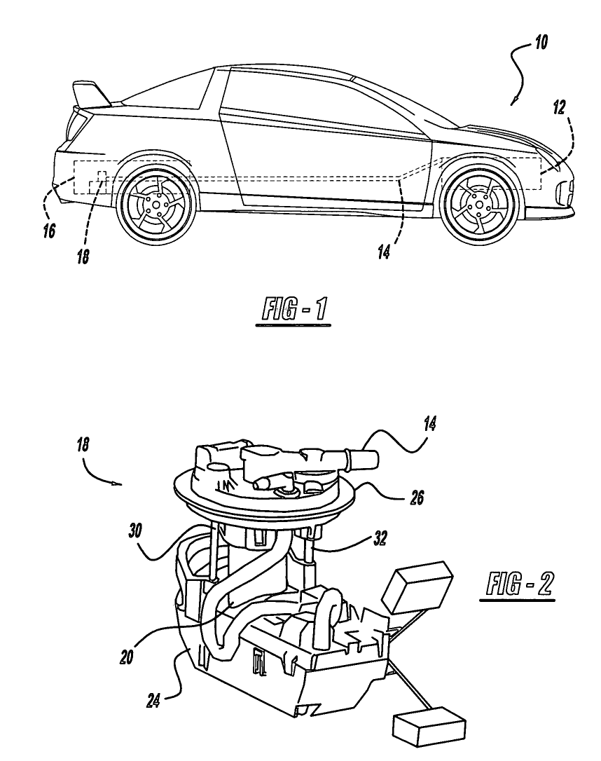

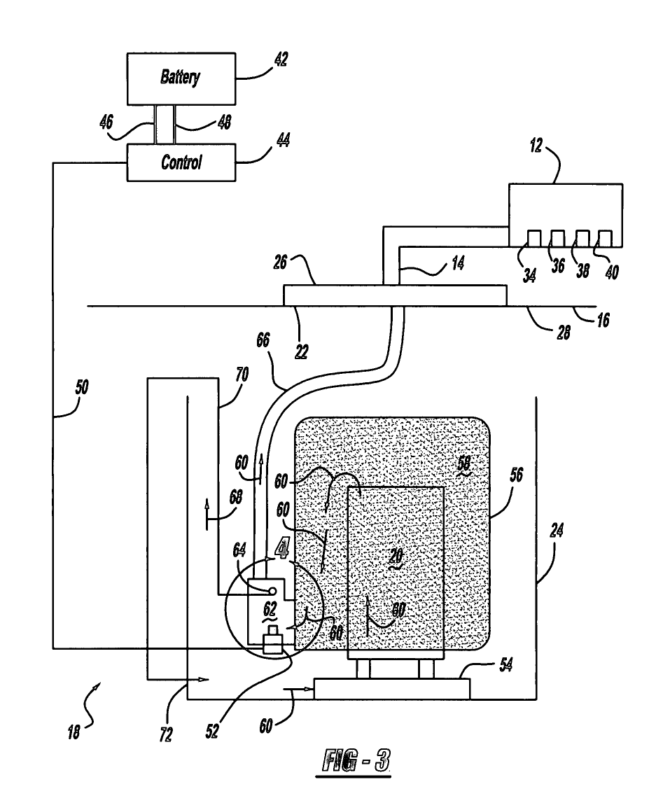

The following description is merely exemplary in nature and is not intended to limit the present disclosure, application, or uses. It should be understood that throughout the drawings, corresponding reference numerals indicate like or corresponding parts and features. With reference first to FIGS. 1-3, a description of components surrounding an electronically controlled pressure regulator for a mechanical returnless fuel system (“MRFS”) will be described. FIG. 1 depicts a vehicle 10, such as an automobile, having an engine 12, a fuel supply line 14, a fuel tank 16, and a fuel pump module 18. The fuel pump module 18 fits within the fuel tank 16, normally as a suspended component, and is normally submerged in or surrounded by varying amounts of liquid fuel within the fuel tank 16 when the fuel tank 16 possesses liquid fuel. FIG. 2 depicts, within the fuel pump module 18, a fuel pump 20 that pumps fuel to the engine 12 through the fuel supply line 14. The fuel pump module 18 depicted in FIG. 2 is an embodiment that may be lowered through and installed about an aperture 22 (FIG. 3) in a top wall of the fuel tank 16. Alternatively, such a fuel pump module 18 may be installed or located on a side wall of a fuel tank; however, for exemplary purposes, the module 18 as depicted in FIGS. 2 and 3 will be used. While the fuel pump module 18 of FIG. 2 depicts a generally horizontally elongated reservoir 24, the reservoir 24 may be designed to be more vertically cylindrical, or other shape, any of which maybe suitable for the teachings of the present invention.

Continuing with FIGS. 2 and 3, a more detailed explanation of the fuel pump module 18, with which the invention operates, will be provided before describing the actual operative workings of the invention. The fuel pump module 18 employs a fuel pump module flange 26 that mounts to the top wall 28 of the fuel tank 16. The flange 26 forms a seal, such as with an o-ring, with the top wall 28 of the fuel tank 16 and is secured to the fuel tank 16 with threads or an interlocking tab mechanism, for example. First and second reservoir rods 30, 32 secure the fuel pump module reservoir 24 to the bottom interior wall of the fuel tank 16, with or without a biasing element such as a spring, as is known in the art. From the top of the flange 26, an engine fuel supply line 14 protrudes to deliver liquid fuel from the pump 20 to the engine 12, and more specifically, to a series of engine fuel injectors 34, 36, 38, 40. FIG. 3 also depicts a vehicle battery 42, a control module 44, electrical power lines 46, 48 between the battery 42 and the control module 44, and a control line 50 between the control module 44 and a solenoid proximate the pressure regulator 52. The control line 50 permits control between the control module 44 and the linear solenoid 92, which will be explained later. A sock type of fuel filter 54 may be attached to the bottom inlet of the fuel pump 20 while a filter case 56 houses a fuel filter 58 that may surround the fuel pump 20 within the case 56.

Continuing with FIG. 3, during typical operation of the fuel pump 20 within the fuel pump module 18, liquid fuel, as represented by arrow 60, enters the reservoir 24 through a jet pump 72, normally comprised of a nozzle and a throat, and then the pump 20 through the filter sock 54. Upon entering the fuel filter sock 54, the liquid fuel 60 is drawn into the fuel pump 20 and discharged from the top of the fuel pump 20 and into the filter 58 within the filter case 56 surrounding the fuel pump 20. The liquid fuel 60 flows into the pressure regulator case 62 where it may be governed by a pressure regulator 52 and pumped through a jet pump port 64. Alternatively, the fuel may pass into a fuel tube 66 before passing through the flange 26 and into the fuel supply line 14 en route to the engine 12. The fuel flow 60 that passes from the jet pump port 64 flows in accordance with fuel flow 68 in jet pump tube 70 where it flows back into the reservoir 24 at the jet pump 72. The jet pump 72, as is known in the art of fuel pump modules, creates a vacuum or low pressure using the fuel flow 68 so that fuel occupying the space surrounding the outside of the reservoir 24 may be drawn into the reservoir 24 where it can then be drawn into the fuel pump 20 as indicated by fuel flow 60.

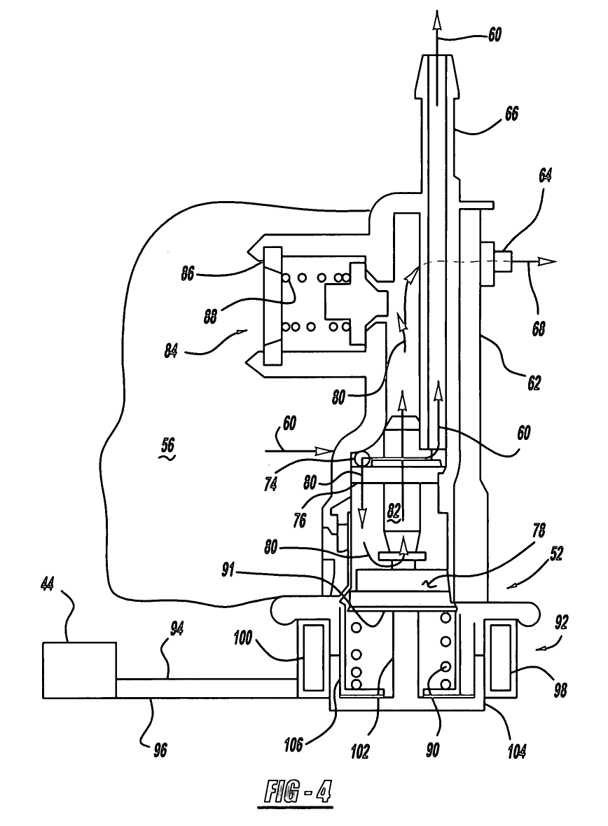

Turning now to FIG. 4, a pressure regulator case 62 further depicts a jet pump port 64 and a pressure regulator 52. The pressure regulator 52 controls the fuel pressure and the fuel flow to the engine 12. Once through the fuel inlet 74, the fuel flow 60 may flow in more than one direction. For instance, the fuel flow 60 from fuel inlet 74 may continue to flow above fuel strainer 76 and into the fuel tube 66 for delivery to the fuel injectors 34, 36, 38, 40 of the engine 12. The fuel flow 60 may also flow through the fuel strainer 76 where it becomes fuel flow 80 and acts upon the pressure plate 78 and compresses a biasing element, such as a spring 90, of the pressure regulator 52. The spring 90 may be secured at its upper end by a spring holder 91, which are both contained by the pressure regulator spring case 106.

Because the fuel pressure from the fuel flow normally forces the pressure plate 78 away from its seat, the fuel flow 80 is permitted to flow into and through the hollow tube 82 where it flows unobstructed from the jet pump port 64 as fuel flow 68 en route to the jet pump 72 of FIG. 3. Alternatively or coincidentally, the fuel flow 80, upon subjection to a high enough pressure, may compress the spring 88 of the fuel relief valve 84 and release fuel from the fuel release orifice 86. The relief valve 84 primarily relieves pressure on the bypass, or low pressure side of the pressure regulator. The bypass side includes the flow path of fuel that passes into the hollow tube 82 and ultimately back into the reservoir 24. The relief valve 84 also provides benefits. One benefit is that the relief valve 84 maintains the pressure regulator operating pressure such that it does not drift or waver, while a second benefit is that governing the bypass side pressure helps ensure the durability of the pressure regulator by maintaining the fuel pressure.

With continued reference to FIG. 4, a solenoid 92 is depicted in a mounted position below, at an end, the pressure regulator case 62, and more specifically, surrounding the pressure regulator 52. The solenoid 92 is an electrically powered device that when energized or operated, temporarily suspends or prevents operation of the pressure regulator 52 thereby causing the fuel pressure in the fuel line 14 and at the fuel injectors 34, 36, 38, 40 to increase above the pressure regulator's normal operating set pressure also known as a regulator set point. The regulator set point is a pressure at which the fuel in the fuel line is normally subjected or regulated to, within a known tolerance band, and is controlled by the pressure regulator 52. To maintain the same pressure in the fuel line 14 during steady-state operation of the engine 12, the fuel pump 20 operates at a steady volumetric output and creates a pressure within the fuel line 14 that is above the pressure regulator's set point, which is governed by the resistance provided by the biasing element, such as spring 90, within the pressure regulator 52. When the pressure of the fuel exiting the orifice 74 is elevated above the opposing pressure governed by the spring 90, the pressure plate 78 in the pressure regulator 52 is forced downward, or away from fuel tube 82. Upon compression of the spring 90, fuel is permitted to flow in accordance with fuel flow 80 such that the fuel may enter a hole in the bottom of the hollow tube 82 and flow through the hollow tube 82 within the pressure regulator case 62.

With continued reference to FIG. 4, parts regarding one embodiment of the solenoid 92 will be explained. The solenoid 92 generally possesses coils 98, 100, a plunger 102, and a plunger guide 104, which moves in accordance with energization of the coils 98, 100. When energized, or supplied with electricity, the coils 98, 100 act as electromagnets. Continuing with FIG. 4, the pressure regulator case 62 may be made of plastic with the solenoid 92 assembled to the pressure regulator 52 such that solenoid 92 protrudes from or is external to the pressure regulator case 62. In the embodiment depicted, the outside diameter of the solenoid 92 is greater than the outside diameter of the pressure regulator case 62 or spring case 106. Pressure regulator spring case 106 is an extension of the pressure regulator case 62.

In a second embodiment of the solenoid 92, as depicted in FIG. 5, the solenoid 92 is external to, and a longitudinal extension of, the pressure regulator case 62. As depicted, the solenoid 92 is in longitudinal alignment with the pressure regulator spring case 106, which also houses the pressure regulator spring 90. FIG. 5 depicts a situation in which the solenoid is not engaged or activated and no fuel is flowing by or through the regulator 52. Continuing, the outside diameter of the solenoid 92 is equal to or less than the diameter of the pressure regulator case 62 and the spring case 106. With the embodiment of FIG. 5, the solenoid 92 makes the overall length of the pressure regulator case 62 and solenoid 92 greater than the embodiment of FIG. 4; however, there are advantages to each embodiment.

The advantages to the embodiment of FIG. 4 is that the length of the combination of the pressure regulator case 62 and the pressure regulator 52 remains shorter in comparison to that of FIG. 5 because the solenoid 92 is around the outside of the spring case 106, and not an extension of the spring case 106. Because the overall length remains relatively short, it may be installed in shallow fuel pump modules within perhaps, shallow fuel tanks, again, relative to the embodiment of FIG. 5. An advantage of the embodiment of FIG. 5 is that although it is longer, overall, to the embodiment of FIG. 4, the outside diameter of the solenoid 92 remains equal to or less than the diameter of the pressure regulator spring case 106. With such a construction, the pressure regulator case 62 may be utilized in fuel pump modules in which a smaller overall diameter, relative to the larger diameter of the solenoid 92 of FIG. 4, is required.

Although the embodiment of FIG. 5 is configured differently than that of FIG. 4, its mechanical makeup is very similar. For instance, the embodiment of FIG. 5 exhibits electromagnets or coils 110, 112, and a plunger guide 114. Upon energizing and de-energizing the coils 110, 112 of the solenoid 92 via the control module 44 and battery 42, the fuel flow and resulting pressure may be controlled, as will now be explained.

With continued reference to FIG. 4, operation of the solenoid 92 in connection with the pressure regulator 52 will be explained. With the use of the control module 44, which may be, for example, an engine control module (“ECU”) or powertrain control module (“PCM”), in conjunction with the solenoid 92, operation of the pressure regulator 52 may be controlled. The control module 44 may be located virtually anywhere on a vehicle, as long as electrical lines, such as electrical lines 94, 96 are connected with the solenoid 92 to provide electrical energy to the solenoid 92 to activate and deactivate the solenoid 92, which in turn, permits or restricts functioning, or activation and deactivation, of the pressure regulator 52. That is, activation and deactivation of the solenoid 92 prevents utilization or permits utilization, respectively, of the pressure regulator 52.

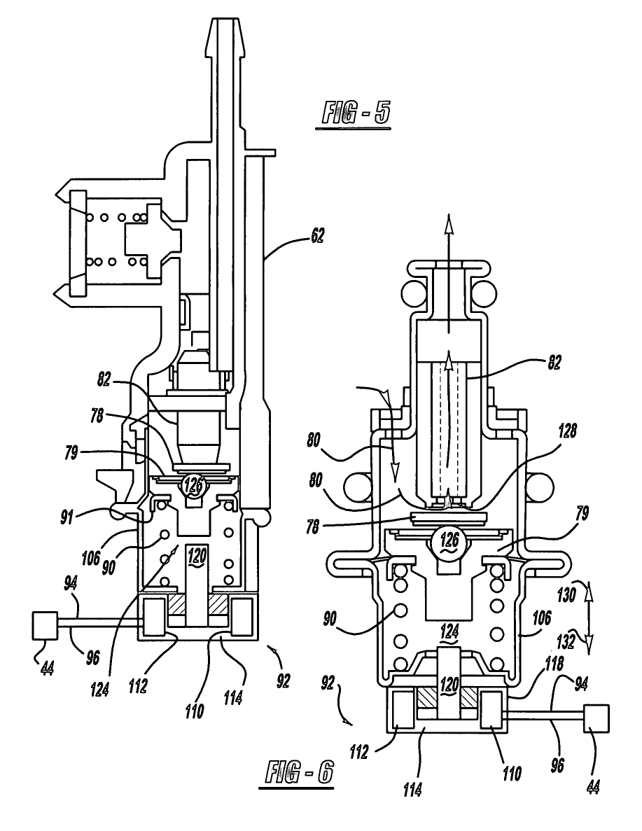

Turning now to FIGS. 6 and 7, operation of the solenoid 92 in connection with the control of fuel through the pressure regulator case 62, will now be explained. For ease of explanation, the views of FIGS. 6 and 7 will be used to exemplify operation of the solenoid 92 and pressure regulator 52. A similar operation would accompany the embodiment of FIGS. 4 and 5, if their operation were described in detail. Continuing, FIG. 6 depicts a solenoid 92 in its disengaged or non-activated state. In its disengaged state, the solenoid 92 permits a gap 124 between the sealing pressure plate sub-assembly 79 and the solenoid plunger 120. The gap 124 exists in the disengaged state of the solenoid 92 because there is no electrical energy supplied to the solenoid coils 110, 112 by the battery 42 via electrical lines 94, 96 as governed or instructed to by the PCM 44. As such, the plunger 120 remains resident in its retracted state as depicted in FIG. 6. When the solenoid 92 is in its disengaged or de-energized state, the pressure regulator is capable of functioning as if the solenoid 92 were not present. In other words, the pressure regulator 52 is capable of operating in accordance with its pre-determined set point or pressure point without the solenoid 92 having any effect on the operation of the pressure regulator 52. For the pressure regulator 52 to function without influence of the solenoid 92, the distance or gap 124 between the plunger 120 and pressure plate sub-assembly 79 must be greater than the lift or gap created between the pressure plate 78 and the hole or inlet orifice 128 at the end of tube 82 as fuel flows into the tube 82. If the gap 124 were not larger than the gap created between the pressure plate 78 and the inlet orifice 128, the pressure regulator would not be permitted to function properly, as the spring 90 would not be permitted to compress or travel as far as the fuel pressure might dictate in accordance with the pressure of the flowing fuel.

Continuing with FIG. 6, when the solenoid 92 is in a non-energized state, the solenoid plunger 120 does not contact the sub-assembly 79 and a gap 124 may be defined therebetween. Now, a typical start routine of the engine 12 and steady state operation of the engine 12 in conjunction with functioning of the solenoid 92 and pressure regulator 52 will be described. Upon turning a vehicle ignition with a key, the fuel pump 20 and the solenoid 92, as depicted in FIG. 7 become energized. Upon energizing, the fuel pump 20 begins pumping fuel at its steady-state capacity and the solenoid 92 moves into its energized position as depicted in FIG. 7, from its non-energized position as depicted in FIG. 6, upon energizing. In one operational example, before the pump 20 generates enough fuel pressure compress the spring 90 and permit fuel flow into the tube 82, the solenoid 92 causes sealing of the orifice 128 at the end of the tube 82 when the plate 78 seals against the hole 128. This results in the pressure regulator 52 becoming ineffective several milliseconds, as an example of time, before the fuel pump 20 begins pumping fuel at a pressure level that may “open” the pressure regulator 52 by compressing the biasing element 90 and moving the plate 78 from the orifice 128.

Turning to FIG. 7, the coils 110, 112, when energized by the battery 42 (FIG. 1) via the PCM 44 and electrical lines 94, 96, cause the plunger 120 to be drawn toward and against the sub-assembly 79. When the plunger 120 is drawn against the sub-assembly 79, the gap 124, as depicted in FIG. 6, becomes eliminated. Additionally, the sub-assembly 79 and accompanying ball 126 and plate 78 are caused to be forced toward the tube 82 as the solenoid plunger 120 contacts the sub-assembly 79. The plate 78 is forced to move and lodges against the hole 128 in the hollow tube 82 to seal the hole 128 and prevent the fuel flow 80 from passing into the hollow tube 82. In covering the hole 128, the fuel pressure of the fuel to the engine is permitted to rise above the set point of the pressure regulator and increase the fuel pressure experienced by the engine during starting. After starting, the solenoid, on command from the PCM 44, disengages and plate 78 moves from the orifice 128 and permits fuel to flow into the tube 82 and again permit functioning of the jet pumps. Additionally, the gap 124 between the sub-assembly 79 and plunger 120 re-appears. The plate 78 and sub-assembly 79 are joined together in construction.

During the energizing process, the solenoid 92 receives power from the battery 42 and actuates, thereby causing the plunger 120 to be forced into the sub-assembly 79, which thereby forces the ball 126 into the plate 78 which lodges against the periphery of the hole 128 a few milliseconds before the fuel pump 20 has time to build enough pressure to open or overcome the bias of the biasing element 90 of the pressure regulator 52. By using such a sequence of events, the pressure regulator, in its traditional sense, is prevented from operating until permitted to do so by the PCM 44. In accordance with one example of the present teachings, the solenoid 92 deactivates 2-5 seconds after starting of the engine 12, as sensed by the PCM 44. When the solenoid deactivates and the pressure regulator 52 is permitted to function in accordance with its designed set point, the fuel flow 80 resumes, as depicted in FIG. 6.

Continuing with FIG. 6, without the activation of the solenoid 92, the fuel flow 80, upon energizing of the fuel pump 20, forces the pressure plate 78 downward and biases the spring 90 as soon as the fuel pump 20 is energized. However, such is not the case with the functioning of the solenoid 92, as depicted in FIG. 7, which essentially removes operation of the spring 90 of the pressure regulator 52 from the fuel system for a short period of time, at least for a period of time before operation of the fuel pump 20. Therefore, upon turning of the ignition key, the solenoid 92 forces the solenoid plunger 120 and sealing pressure plate sub-assembly 79 in accordance with arrow 130 to prevent operation of the spring 90 of the pressure regulator 52, and then, just a few milliseconds later, the fuel pump 20 may be activated to pump fuel to the engine 12 at a pressure higher than if the solenoid was not preventing operation of the spring 90 of the pressure regulator 52. In other words, the pressure at which fuel is pumped to the engine 12 when the solenoid 92 is activated is higher than the pressure regulator's set point or set pressure during the period when the solenoid 92 is not activated. Such is the case because the fuel pump 20 normally pumps fuel at a pressure higher than the set pressure of the pressure regulator 52, which normally causes the spring 90 to compress. When the solenoid 92 is de-activated, the pressure plate 78 and ball 126 move in accordance with arrow 132 as opposed to the activated direction in accordance with arrow 130.

The solenoid 92 may be set to automatically deactivate after a set amount of time, for example, two seconds, after which passage of time the engine 12 should operate at steady state. Alternatively, the PCM 44 may be programmed to deactivate the solenoid 92 when the PCM 44 detects that the engine 12 is started and operating under steady-state conditions, regardless of time.

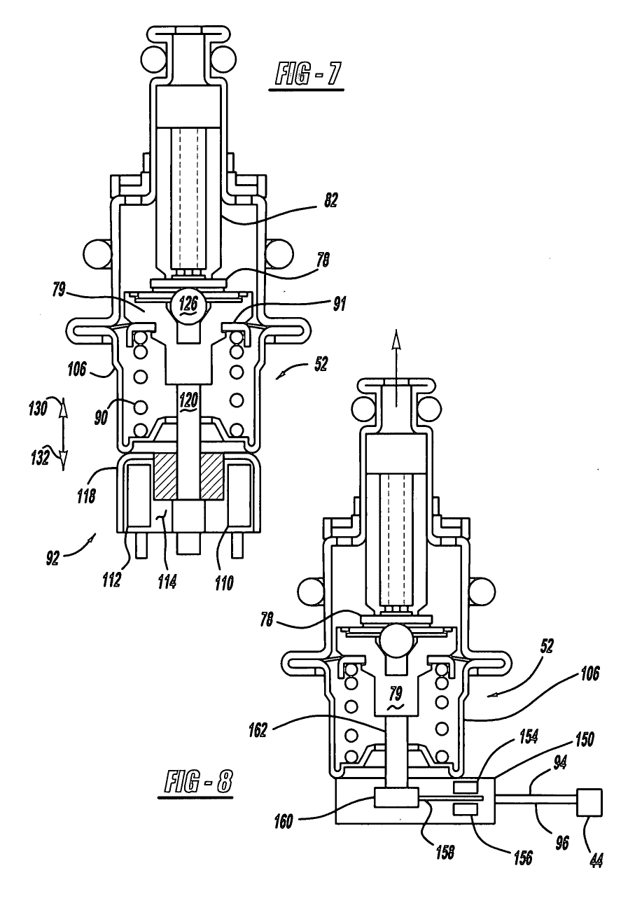

In another embodiment of the present teachings in accordance with FIGS. 8-10b, a rotary solenoid 150 is mounted to the pressure regulator case 106 or integral to the pressure regulator case 106. In either construction, FIG. 8 depicts a rotary solenoid 150 equipped with coils 154, 156, which when energized by a battery via a control module 44 and electrical and communication lines 94, 96, that cause the solenoid shaft 158 to rotate about its longitudinal axis. When the solenoid shaft 158 rotates, the connected solenoid lobe 160, which contacts the plunger 162, also rotates. As the solenoid lobe 160 rotates, the plunger 162 moves toward the sub-assembly 79 and contacts the sub-assembly 79. The plate 78 contacts the periphery of the hole 128 to seal the hole 128 from liquid fuel, as described above in the prior embodiment.

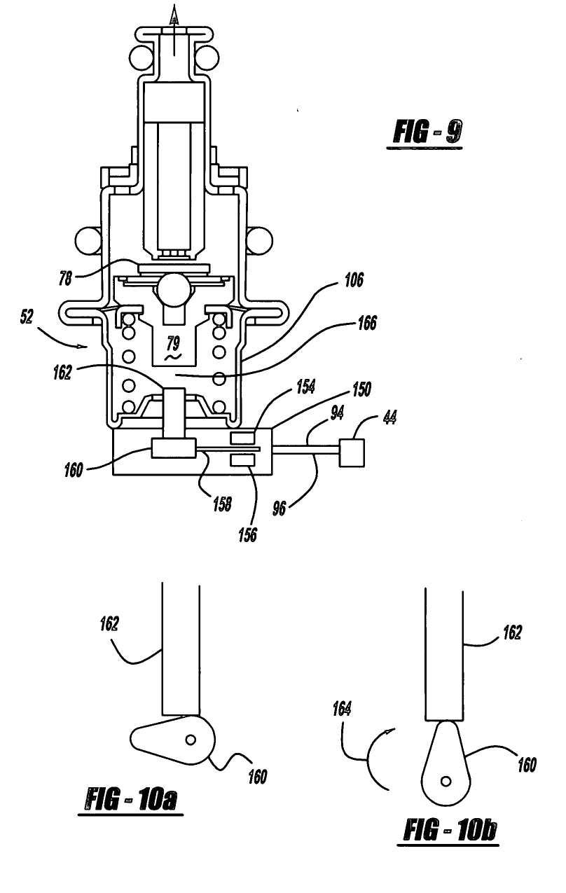

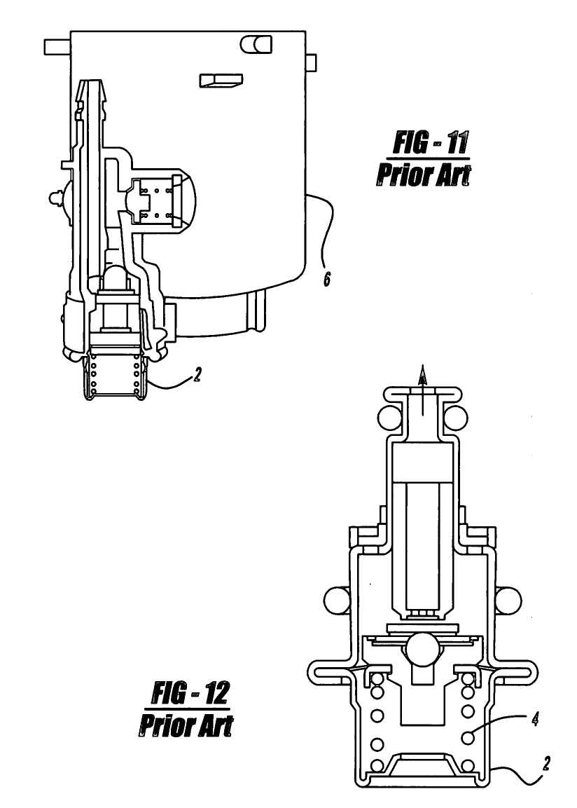

FIG. 9 depicts the shaft 158 of the rotary solenoid 150 rotated to a different position. More specifically, because the lobe 160 is non-circular, as depicted in the end view of FIGS. 10a and 10b, when it rotates, the lift that that plunger 162 experiences is different than if the lobe were circular. As FIG. 9 depicts, when the lobe 160 is rotated to the position depicted in FIG. 10a, the plunger 162 is at a lower, or position farther from the sub-assembly 79, than if the lobe 160 is rotated to the position depicted in FIG. 10b, which results in the plunger 162 being rotated, in accordance with arrow 164, to a position that causes the plunger 162 to eliminate the gap 166 and contact and move the sub-assembly 79 so that the hole 128 may be closed by the plate 78, as described above. The rotary solenoid 150 is a space-savings alternative to the linear solenoid 92 depicted and described above because the longitudinal axis of the coils 154, 156 are perpendicular to, as opposed to parallel to, the plunger 162.

There are multiple advantages to the teachings of the present invention. First, tailpipe emissions will be reduced during starting of a vehicle engine because the fuel pressure at which the vehicle is started will be increased thus resulting in achieving more optimal air to fuel ratios, more quickly, for the combustion process. Such is the result of essentially “removing” the functionality of the pressure regulator 52 at engine starting by using the solenoid 92. In other words, when the pressure regulator 52 is deactivated and rendered ineffective upon activating the solenoid 92, the starting fuel pressure rises above the set point of the pressure regulator, resulting in quicker restarts and reduced tailpipe emissions, than a pressure regulator with no solenoid 92. A second advantage is that more optimal combustion can be achieved more quickly, even under conditions that might otherwise result in poor (e.g. late) starts or vapor lock, such as ambient high temperatures or ambient low pressures.

An advantage of employing the rotary solenoid 150 is that the coils 154, 156 may be placed perpendicular, with respect to their lengths, to the plunger 162, thus minimizing the overall depth of the solenoid and pressure regulator packaging, as compared to a linear solenoid. That is, with the lengths of the coils 154, 156 oriented in a direction perpendicular to the plunger 162, the coils 154, 156 occupy less space at the end of the pressure regulator 52 than that occupied by a linear solenoid whose coils may be parallel to the plunger 162.

What is claimed is:

1. A pressure regulator within a pressure regulator case, the pressure regulator comprising:
a solenoid located at an end of the pressure regulator, the solenoid for governing functioning of the pressure regulator.

2. The pressure regulator of claim 1, further comprising:
a solenoid case within which the solenoid is located, wherein the solenoid case has a diameter equal to or less than the pressure regulator case.

3. The pressure regulator of claim 1, further comprising:
a solenoid case within which the solenoid is located, wherein the solenoid case has a diameter greater than the pressure regulator case.

4. The pressure regulator of claim 1, the pressure regulator further comprising:
a spring secured within a pressure regulator spring case;
a sealing pressure plate sub-assembly that lies upon the spring and within the pressure regulator spring case; and
a solenoid plunger within the solenoid, the solenoid plunger contacting the sealing pressure plate sub-assembly, which covers and uncovers an orifice through which fuel flows.

5. The pressure regulator of claim 4, further comprising:
a ball element at the end of the sealing pressure plate sub-assembly that covers and uncovers the orifice, upon activation and deactivation of the solenoid.

6. The pressure regulator of claim 5, further comprising:
a controller that controls activation and de-activation of the solenoid.

7. The pressure regulator of claim 6, further comprising:
a battery for supplying electrical energy to the controller and the solenoid.

8. A pressure regulator within a pressure regulator case, the pressure regulator comprising:
a spring secured by a spring holder;
a sealing pressure plate sub-assembly that passes through the spring and spring holder; and
a solenoid and a solenoid plunger, the solenoid plunger contacting the sealing pressure plate sub-assembly to govern fuel pressure within the pressure regulator case.

9. The pressure regulator of claim 8, wherein the solenoid is located at an end of the pressure regulator case.

10. The pressure regulator of claim 8, further comprising:
a solenoid case, wherein the solenoid case has a diameter equal to or less than the pressure regulator spring case.

11. The pressure regulator of claim 8, further comprising:
a solenoid case, wherein the solenoid case has a diameter greater than the pressure regulator spring case.

12. The pressure regulator of claim 8, further comprising:
a ball element at the end of the sealing pressure plate sub-assembly to govern the flow of fuel.

13. The pressure regulator of claim 8, further comprising:
a controller, wherein the controller activates and de-activates the solenoid.

14. A pressure regulator within a pressure regulator case, the pressure regulator comprising:
a spring secured by a spring holder within a pressure regulator spring case;
a sealing pressure plate sub-assembly that passes through the spring and spring holder;
a solenoid located at an end of the pressure regulator spring case; and
a solenoid plunger, the solenoid plunger contacting the sealing pressure plate sub-assembly, thereby governing fuel pressure within the pressure regulator case.

15. The pressure regulator of claim 14, further comprising:
a solenoid case within which the solenoid is located, wherein the solenoid case has a diameter equal to or less than the pressure regulator case.

16. The pressure regulator of claim 15, further comprising:
a solenoid case within which the solenoid is located, wherein the solenoid case has a diameter greater than the pressure regulator case.

17. The pressure regulator of claim 14, further comprising:
a hollow tube defining an end hole; and
a ball element at the end of the sealing pressure plate sub-assembly that seals against the hole to govern the flow of fuel.

18. The pressure regulator of claim 14, further comprising:
a controller, wherein the controller energizes and de-energizes the solenoid; and
a battery, wherein the battery supplies electricity to the controller and the solenoid.

19. The pressure regulator of claim 14, wherein the solenoid is a linear solenoid.

20. The pressure regulator of claim 14, wherein the solenoid is a rotary solenoid.
